(19) United States
(12) Patent Application Publication
(10) Pub. No.: US 2025/0063544 A1
(43) Pub. Date: Feb. 20, 2025

(54) DOWNLINK COMMUNICATION INFORMATION AND GAP CONFIGURATION FOR PAGING EARLY INDICATION

(71) Applicant: QUALCOMM Incorporated, San Diego, CA (US)

(72) Inventors: Jing LEI, San Diego, CA (US); Prasad Reddy KADIRI, San Diego, CA (US); Ozcan OZTURK, San Diego, CA (US)

(21) Appl. No.: 18/452,318

(22) Filed: Aug. 18, 2023

(51) Int. Cl. H04W 68/02

(52) U.S. Cl. CPC H04W 68/02

(57) ABSTRACT

Various aspects of the present disclosure generally relate to wireless communication. In some aspects, a user equipment (UE) may receive configuration information that configures a paging early indication (PEI) communication, the PEI communication including at least one of a public warning system field, a primary system information (SI) change indication field, a secondary SI change indication field, or a paging physical downlink shared channel indication field. The UE may receive the PEI communication based at least in part on the configuration information. Numerous other aspects are described.

### FIELD OF THE DISCLOSURE

Aspects of the present disclosure generally relate to wireless communication and to techniques and apparatuses for downlink communication information and a gap configuration for a paging early indication.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configuration information that configures a paging early indication (PEI) communication, the PEI communication including at least one of a public warning system (PWS) field, a primary system information (SI) change indication field, a secondary SI change indication field, or a paging physical downlink shared channel (PDSCH) indication field. The method may include receiving the PEI communication based at least in part on the configuration information.

Some aspects described herein relate to a method of wireless communication performed by a UE. The method may include receiving configuration information indicating, at least one of a first component carrier associated with a PEI occasion or a first downlink bandwidth part (BWP) associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The method may include receiving at least one of a PEI communication in the PEI occasion or a paging communication in the paging occasion based at least in part on the configuration information.

Some aspects described herein relate to a method of wireless communication performed by a network node. The method may include transmitting, to a UE, configuration information that configures a PEI communication, the PEI communication including at least one of a PWS field, a primary SI change indication field, a secondary SI change indication field, or a paging PDSCH indication field. The method may include transmitting, to the UE, the PEI communication based at least in part on the configuration information.

Some aspects described herein relate to a method of wireless communication performed by a network node. The method may include transmitting, to a UE, configuration information indicating, at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The method may include transmitting, to the UE, at least one of a PEI communication in the PEI occasion or a paging communication in the paging occasion based at least in part on the configuration information.

Some aspects described herein relate to a UE for wireless communication. The UE may include one or more memories and one or more processors coupled to the one or more memories. The one or more processors may be configured, individually or in any combination, to receive configuration information that configures a PEI communication, the PEI communication including at least one of a PWS field, a primary SI change indication field, a secondary SI change indication field, or a paging PDSCH indication field. The one or more processors, individually or in any combination, may be configured to receive the PEI communication based at least in part on the configuration information.

Some aspects described herein relate to a UE for wireless communication. The UE may include one or more memories and one or more processors coupled to the one or more memories. The one or more processors may be configured, individually or in any combination, to receive configuration information indicating, at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The one or more processors may be configured, individually or in any combination, to receive at least one of a PEI communication in the PEI occasion or a paging communication in the paging occasion based at least in part on the configuration information.

Some aspects described herein relate to a network node for wireless communication. The network node may include one or more memories and one or more processors coupled to the one or more memories. The one or more processors may be configured, individually or in any combination, to transmit, to a UE, configuration information that configures a PEI communication, the PEI communication including at least one of a PWS field, a primary SI change indication field, a secondary SI change indication field, or a paging PDSCH indication field. The one or more processors may be configured, individually or in any combination, to transmit, to the UE, the PEI communication based at least in part on the configuration information.

Some aspects described herein relate to a network node for wireless communication. The network node may include one or more memories and one or more processors coupled to the one or more memories. The one or more processors may be configured, individually or in any combination, to transmit, to a UE, configuration information indicating, at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The one or more processors may be configured, individually or in any combination, to transmit, to the UE, at least one of a PEI communication in the PEI occasion or a paging communication in the paging occasion based at least in part on the configuration information.

Some aspects described herein relate to a non-transitory computer-readable medium that stores a set of instructions for wireless communication by a UE. The set of instructions, when executed by one or more processors of the UE, may cause the UE to receive configuration information that configures a PEI communication, the PEI communication including at least one of a PWS field, a primary SI change indication field, a secondary SI change indication field, or a paging PDSCH indication field. The set of instructions, when executed by one or more processors of the UE, may cause the UE to receive the PEI communication based at least in part on the configuration information.

Some aspects described herein relate to a non-transitory computer-readable medium that stores a set of instructions for wireless communication by a UE. The set of instructions, when executed by one or more processors of the UE, may cause the UE to receive configuration information indicating, at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The set of instructions, when executed by one or more processors of the UE, may cause the UE to receive at least one of a PEI communication in the PEI occasion or a paging communication in the paging occasion based at least in part on the configuration information.

Some aspects described herein relate to a non-transitory computer-readable medium that stores a set of instructions for wireless communication by a network node. The set of instructions, when executed by one or more processors of the network node, may cause the network node to transmit, to a UE, configuration information that configures a PEI communication, the PEI communication including at least one of a PWS field, a primary SI change indication field, a secondary SI change indication field, or a paging PDSCH indication field. The set of instructions, when executed by one or more processors of the network node, may cause the network node to transmit, to the UE, the PEI communication based at least in part on the configuration information.

Some aspects described herein relate to a non-transitory computer-readable medium that stores a set of instructions for wireless communication by a network node. The set of instructions, when executed by one or more processors of the network node, may cause the network node to transmit, to a UE, configuration information indicating, at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The set of instructions, when executed by one or more processors of the network node, may cause the network node to transmit, to the UE, at least one of a PEI communication in the PEI occasion or a paging communication in the paging occasion based at least in part on the configuration information.

Some aspects described herein relate to an apparatus for wireless communication. The apparatus may include means for receiving configuration information that configures a PEI communication, the PEI communication including at least one of a PWS field, a primary SI change indication field, a secondary SI change indication field, or a paging PDSCH indication field. The apparatus may include means for receiving the PEI communication based at least in part on the configuration information.

Some aspects described herein relate to an apparatus for wireless communication. The apparatus may include means for receiving configuration information indicating, at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The apparatus may include means for receiving at least one of a PEI communication in the PEI occasion or a paging communication in the paging occasion based at least in part on the configuration information.

Some aspects described herein relate to an apparatus for wireless communication. The apparatus may include means for transmitting, to a UE, configuration information that configures a PEI communication, the PEI communication including at least one of a PWS field, a primary SI change indication field, a secondary SI change indication field, or a paging PDSCH indication field. The apparatus may include means for transmitting, to the UE, the PEI communication based at least in part on the configuration information.

Some aspects described herein relate to an apparatus for wireless communication. The apparatus may include means for transmitting, to a UE, configuration information indicating, at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The apparatus may include means for transmitting, to the UE, at least one of a PEI communication in the PEI occasion or a paging communication in the paging occasion based at least in part on the configuration information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 illustrates an example of a wireless network in which a UE may support additional communication modes, in accordance with the present disclosure.

FIGS. 5A-5C are diagrams of an example associated with downlink control information and a gap configuration for a paging early indication, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

In a wireless communication system, a user equipment (UE) may, during some periods of time, not have an active connection with a network node and, therefore, may not be able to receive signaling dedicated to the UE. For example, a UE operating in a radio resource control (RRC) idle mode does not have an RRC connection with a network node and, therefore, cannot not receive dedicated signaling from the network node. Rather, the UE only receives broadcast information (e.g., synchronization signal blocks (SSBs) or system information blocks (SIBs)). One technique by which the network can establish communication with the UE during such a period of time is through a paging procedure.

In some cases, a paging procedure may include the network node sending a paging message to the UE. The paging message may include a request to wake from the idle mode and reconnect to the network. The paging message may be transmitted in a physical downlink shared channel (PDSCH) communication (e.g., a paging PDSCH). Prior to transmitting the paging PDSCH in a paging occasion (PO), the network node may transmit, and the UE may receive, a physical downlink control channel (PDCCH) communication (e.g., a paging PDCCH) scheduling the paging PDSCH. The network node may transmit the paging PDCCH and the paging PDSCH within a PO associated with the UE. The PO may be a set of resources in which the UE is configured to check for paging messages for the UE.

With increasing network densification and massive Internet-of-Things (IoT) deployment in wireless communication networks, system load and/or UE resource consumption spent for paging updates may be onerous. For example, in sixth generation (6G) networks, a network node may page a UE for multiple causes, such as a public warning system (PWS) notification, a remaining minimum system information (RMSI) and/or other system information (OSI) modification for one or multiple UE types, mobile terminating (MT) data targeting a single UE or a group of UEs (e.g., voice, small data transfer (SDT), multicast and broadcast service (MBS), or similar MT data), or the like.

Moreover, in some examples, a paging message may be inapplicable to a UE that is nonetheless able to receive and decode the message. For example, depending on the cause of paging, certain UEs may take difference courses of action with different impacts. For example, upon decoding a paging PDCCH, a UE may determine whether or not to change the UE's RRC state, suspend and/or interrupt the UE's ongoing activities, or the like. In some cases, if SDT is ongoing at a UE and/or downlink/uplink tunnels are established for data radio bearers (DRBs) at the UE, the UE may not need to decode a paging message. In some other cases, if a system information (SI) modification is relevant for a different UE type, a UE may not need to decode a short message associated with the paging message. In that regard, UEs may unnecessarily consume power, computing, and network resources to receive and decode a paging PDCCH for an irrelevant paging message.

According to some aspects described herein, a paging early indication (PEI) communication may be utilized to identify a priority and/or a cause of paging, and thus to indicate to a particular UE whether a paging message is relevant to the UE and/or whether the paging message should be decoded by the UE. For example, a PEI communication (e.g., a downlink control information (DCI) communication) may include a PWS indication field that may be used to indicate that a paging message is associated with a PWS notification, a primary SI change field that may be used to indicate that a paging message is associated with a primary SI change, a secondary SI change field that may be used to indicate that a paging message is associated with a secondary SI change, and/or a paging PDSCH indication field that may be used to indicate that a paging message is associated with a paging PDSCH. In such aspects, a UE receiving the PEI may conserve power, computing, and network resources that would have otherwise been consumed by the UE interrupting ongoing activities (e.g., voice, SDT, MBS) and/or by monitoring unnecessary POs in an upcoming paging cycle. Additionally, in some aspects, a UE may be configured with a gap pattern, such as for a purpose of switching component carriers and/or downlink bandwidth parts (BWPs) in order to process a downlink reference signal (DLRS), a control channel, a data channel, or the like associated with a paging message that is transmitted outside an initial BWP, thereby enabling more flexible resource allocation and thus more efficient usage of network resources.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

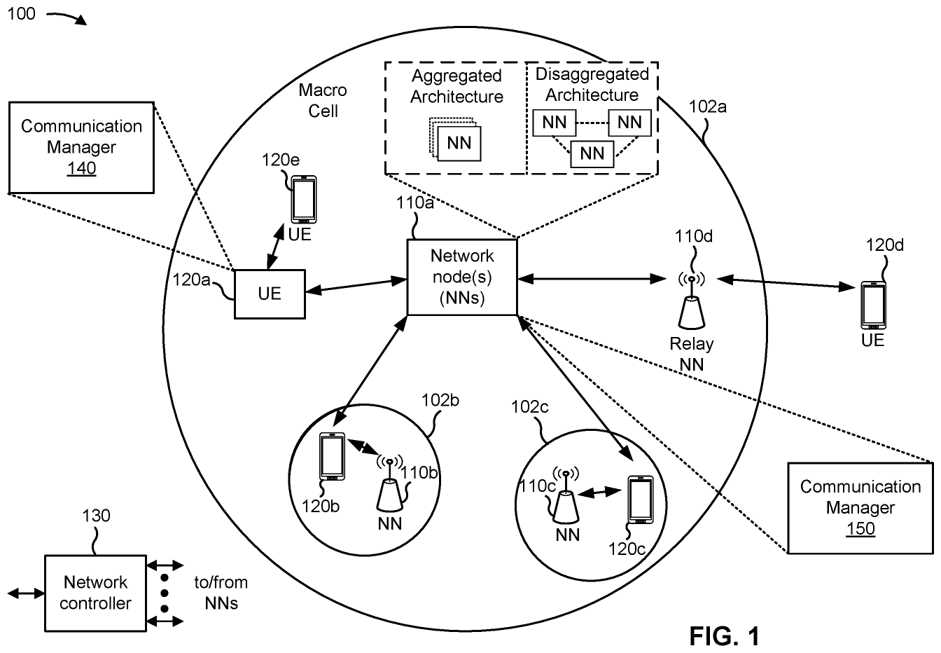

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered IoT devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHZ-7.125 GHZ) and FR2 (24.25 GHZ-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHz-71 GHz), FR4 (52.6 GHZ-114.25 GHz), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information that configures a PEI communication, the PEI communication including at least one of a PWS field, a primary SI change indication field, a secondary SI change indication field, or a paging PDSCH indication field; and receive the PEI communication based at least in part on the configuration information. In some other aspect, the communication manager 140 may receive configuration information indicating at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP; and receive at least one of a PEI communication in the PEI occasion or a paging communication in the paging occasion based at least in part on the configuration information. Additionally, or alternatively, the communication manager 140 may perform one or more other operations described herein.

In some aspects, the network node 110 may include a communication manager 150. As described in more detail elsewhere herein, the communication manager 150 may transmit, to a UE, configuration information that configures a PEI communication, the PEI communication including at least one of a PWS field, a primary SI change indication field, a secondary SI change indication field, or a paging PDSCH indication field; and transmit, to the UE, the PEI communication based at least in part on the configuration information. In some other aspects, the communication manager 150 may transmit, to a UE, configuration information indicating at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP; and transmit, to the UE, at least one of a PEI communication in the PEI occasion or a paging communication in the paging occasion based at least in part on the configuration information. Additionally, or alternatively, the communication manager 150 may perform one or more other operations described herein.

As indicated above, FIG. 1 is provided as an example. Other examples may differ from what is described with regard to FIG. 1.

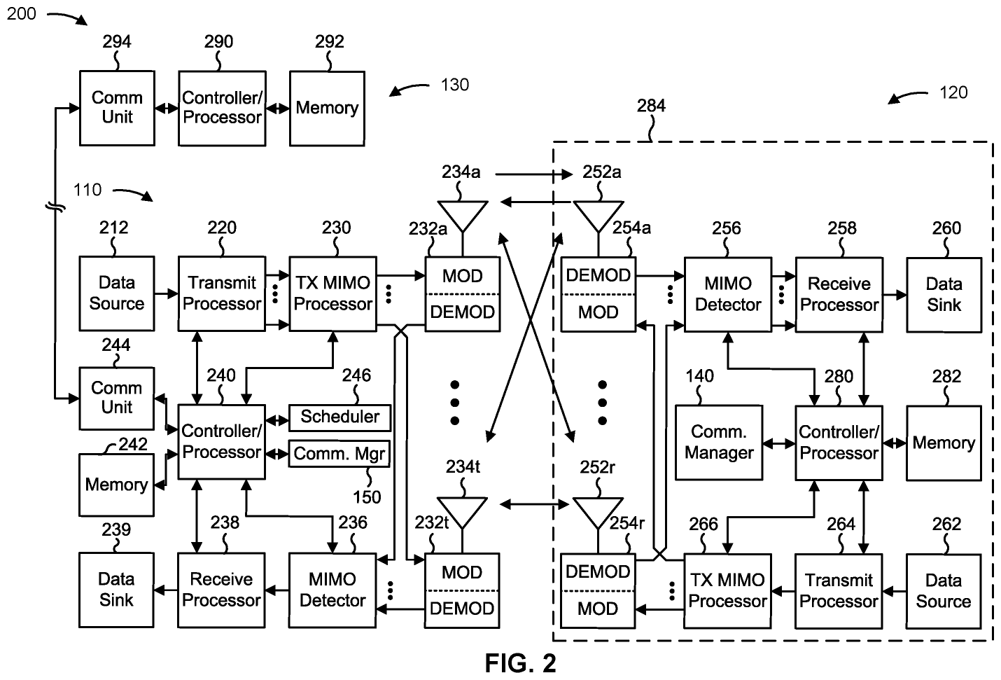

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

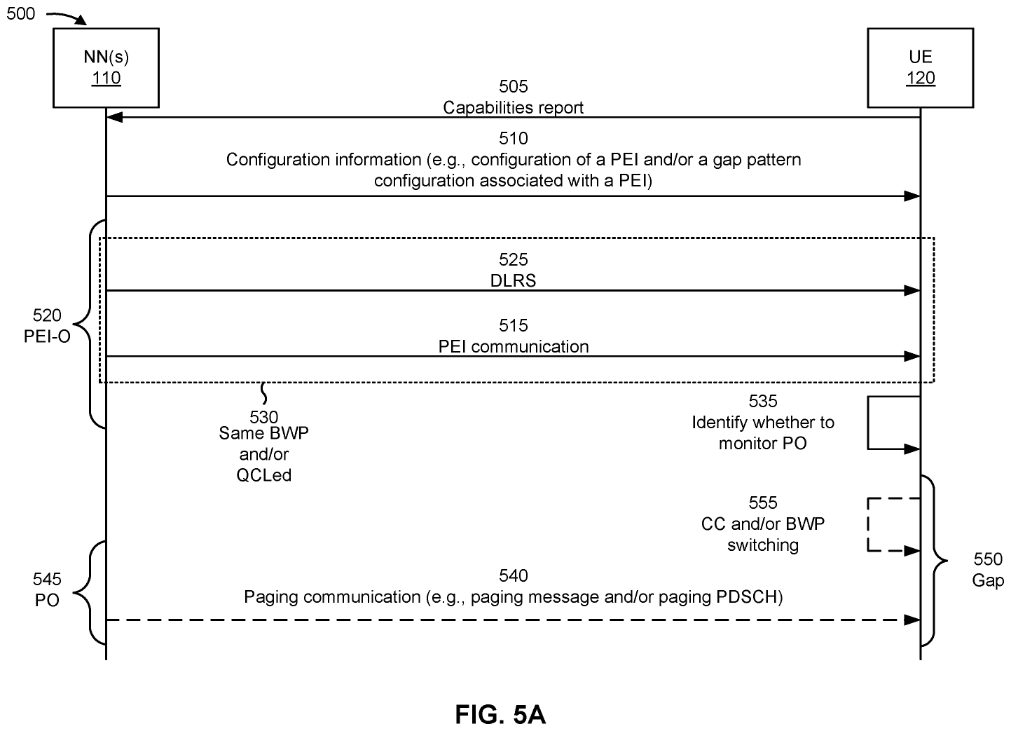

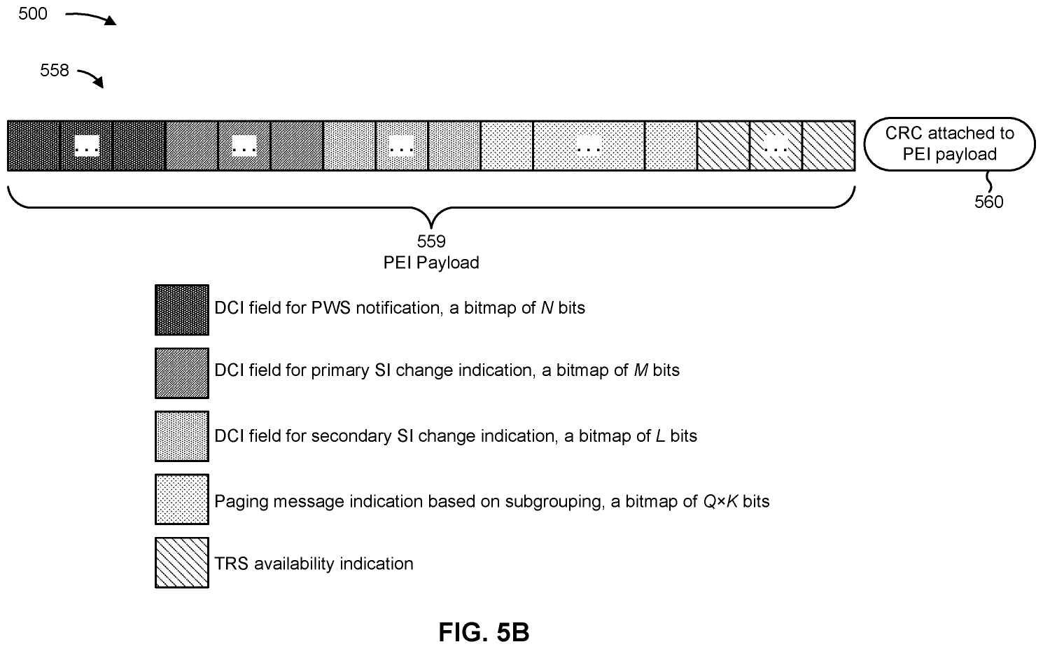

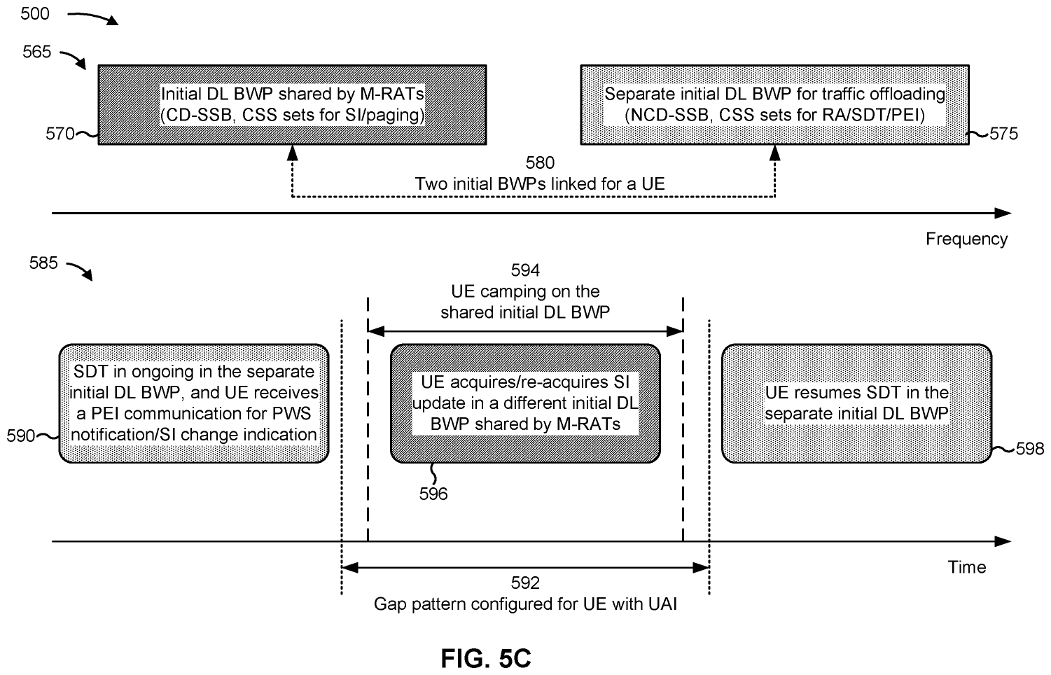

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5A-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5A-11).

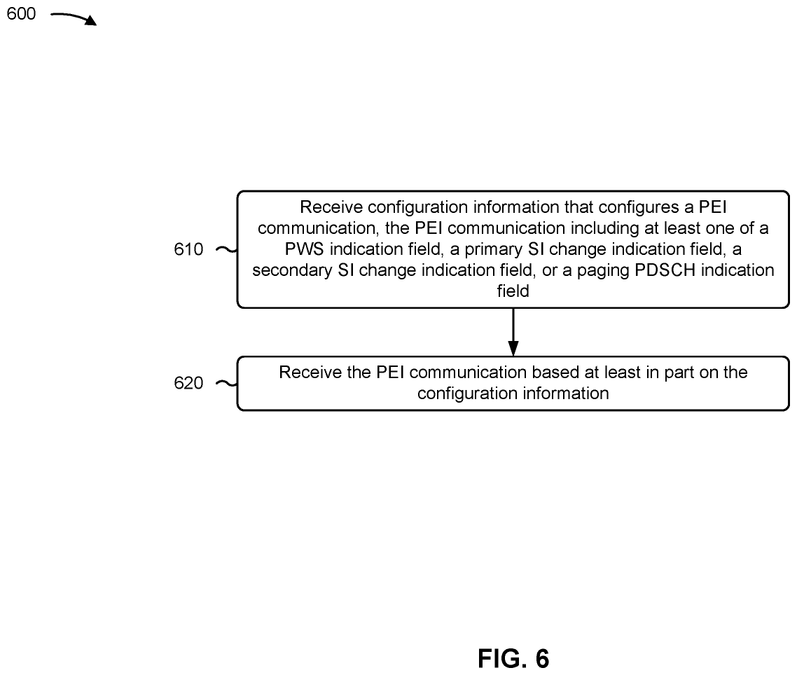

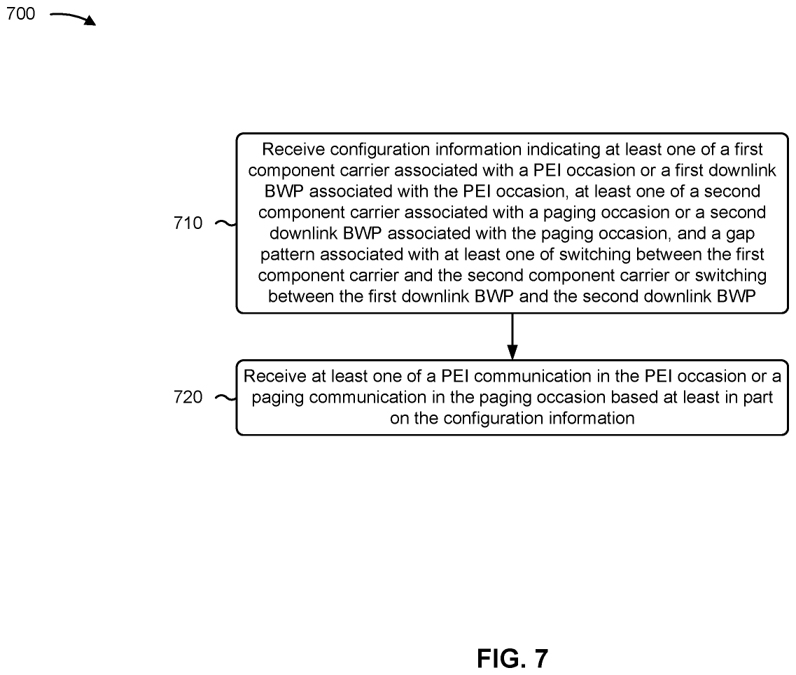

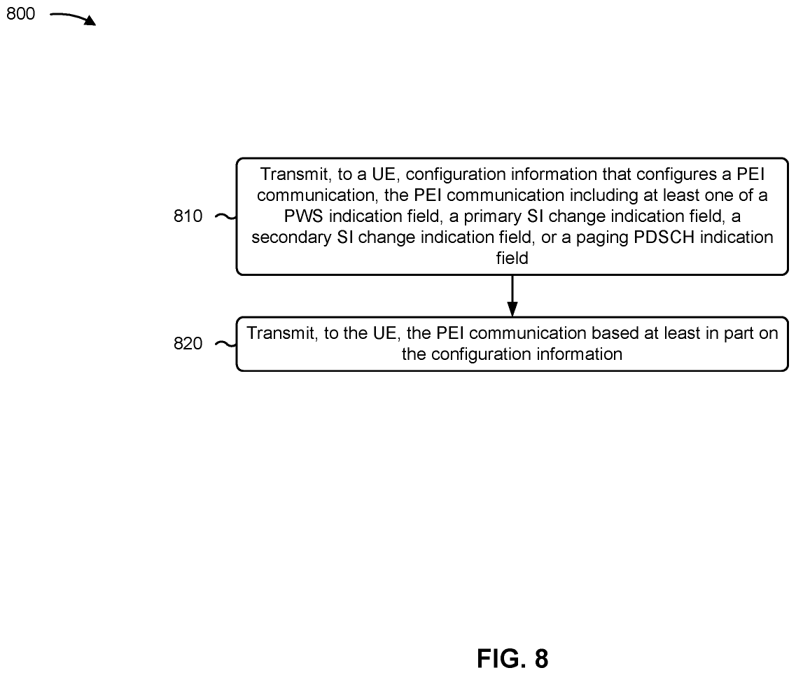

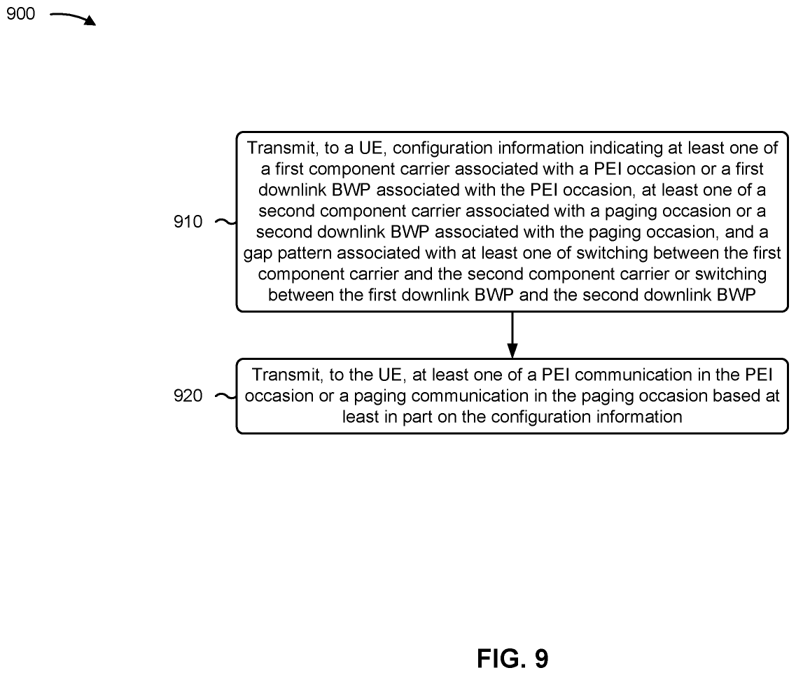

The controller/processor 240 of the network node 110, the controller/processor 280 of the UE 120, and/or any other component(s) of FIG. 2 may perform one or more techniques associated with DCI and a gap configuration for a PEI, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving configuration information that configures a PEI communication, the PEI communication including at least one of a PWS field, a primary SI change indication field, a secondary SI change indication field, or a paging PDSCH indication field; and/or means for receiving the PEI communication based at least in part on the configuration information. In some other aspects, the UE 120 includes means for receiving configuration information indicating at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP; and/or means for receiving at least one of a PEI communication in the PEI occasion or a paging communication in the paging occasion based at least in part on the configuration information. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting, to a UE, configuration information that configures a PEI communication, the PEI communication including at least one of a PWS field, a primary SI change indication field, a secondary SI change indication field, or a paging PDSCH indication field; and/or means for transmitting, to the UE, the PEI communication based at least in part on the configuration information. In some other aspects, the network node 110 includes means for transmitting, to a UE, configuration information indicating at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP; and/or means for transmitting, to the UE, at least one of a PEI communication in the PEI occasion or a paging communication in the paging occasion based at least in part on the configuration information. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU. DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

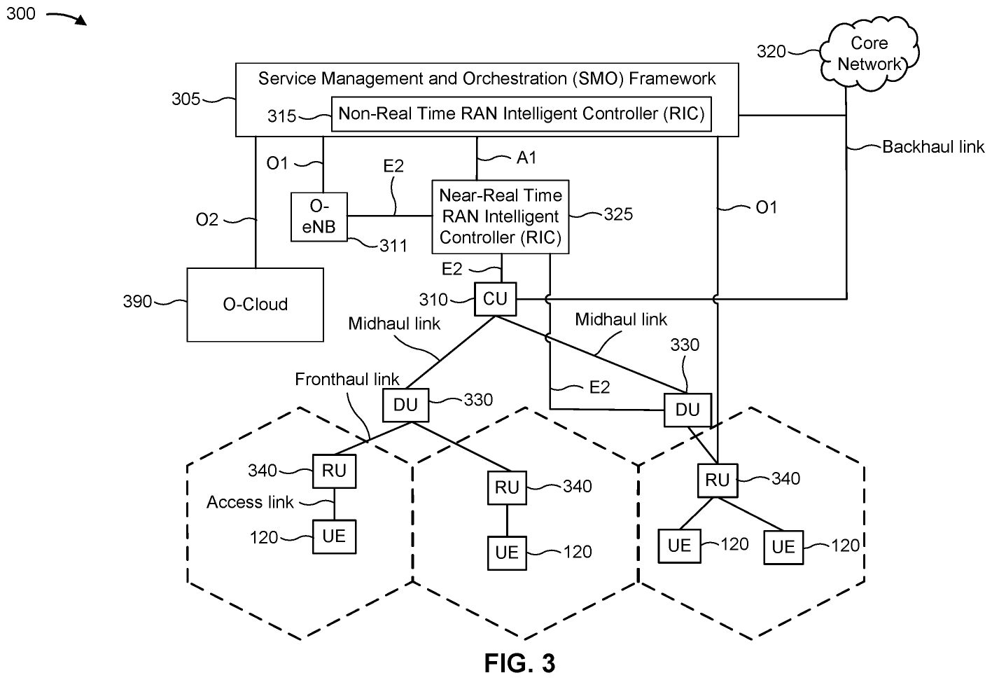

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUS 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

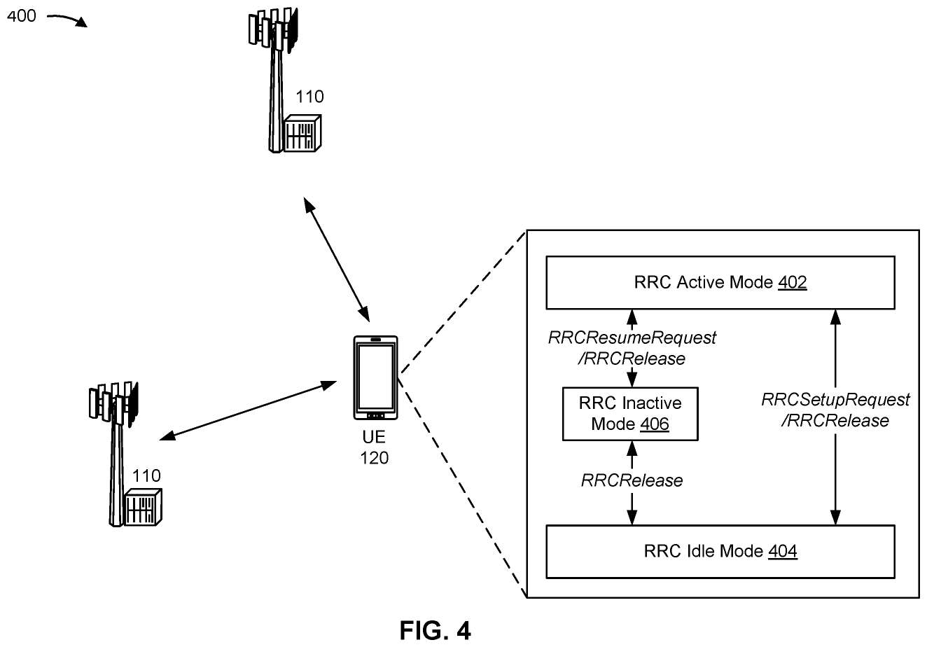

FIG. 4 illustrates an example 400 of a wireless network (e.g., wireless network 100) in which a UE 120 may support additional communication modes, in accordance with the present disclosure. The UE 120 may be communicatively connected with one or more network nodes 110 in the wireless network. For example, the UE 120 may be connected to the one or more network nodes 110 in a dual connectivity configuration. In this case, a first network node 110 may serve the UE 120 as a master node and a second network node 110 may serve the UE 120 as a secondary node.

As illustrated in FIG. 4, the UE 120 may support a connected communication mode (e.g., an RRC active mode 402), an idle communication mode (e.g., an RRC idle mode 404), and an inactive communication mode (e.g., an RRC inactive mode 406). RRC inactive mode 406 may functionally reside between RRC active mode 402 and RRC idle mode 404.

The UE 120 may transition between different modes based at least in part on various commands and/or communications received from the one or more network nodes 110. For example, the UE 120 may transition from RRC active mode 402 or RRC inactive mode 406 to RRC idle mode 404 based at least in part on receiving an RRCRelease communication. As another example, the UE 120 may transition from RRC active mode 402 to RRC inactive mode 406 based at least in part on receiving an RRCRelease with suspendConfig communication. As another example, the UE 120 may transition from RRC idle mode 404 to RRC active mode 402 based at least in part on receiving an RRCSetupRequest communication. As another example, the UE 120 may transition from RRC inactive mode 406 to RRC active mode 402 based at least in part on receiving an RRCResumeRequest communication.

When transitioning to RRC inactive mode 406, the UE 120 and/or the one or more network nodes 110 may store a UE context (e.g., an access stratum (AS) context and/or higher-layer configurations). This permits the UE 120 and/or the one or more network nodes 110 to apply the stored UE context when the UE 120 transitions from RRC inactive mode 406 to RRC active mode 402 in order to resume communications with the one or more network nodes 110, which reduces latency of transitioning to RRC active mode 402 relative to transitioning to the RRC active mode 402 from RRC idle mode 404.

In some cases, the UE 120 may communicatively connect with a new master node when transitioning from RRC idle mode 404 or RRC inactive mode 406 to RRC active mode 402 (e.g., a master node that is different from the last serving master node when the UE 120 transitioned to RRC idle mode 404 or RRC inactive mode 406). In this case, the new master node may be responsible for identifying a secondary node for the UE 120 in the dual connectivity configuration.

In some examples, the network nodes 110 may be associated with the same RAT, while, in some other examples, the network nodes 110 may be associated with a different RAT. For example, in 6G technologies, in order to achieve higher throughputs from the UE 120 perspective (e.g., 100+ Gbps throughputs), a UE 120 may be configured to aggregate multiple frequency bands, such as 6G FR1 (which, in some cases, may be capable of achieving throughputs of up to 18 Gbps), 6G FR2 (which, in some cases, may be capable of achieving throughputs of up to 42 Gbps), and/or 6G FR3 (which, in some cases, may be capable of achieving throughputs of up to 45 Gbps), among other frequency bands. Additionally, or alternatively, for initial deployment of 6G technologies, when all frequency bands may not be initially upgraded to support 6G technologies, a UE 120 may be configured to aggregate 5G and 6G frequency bands, such as 5G FR1 (which, in some cases, may be capable of achieving throughputs of up to 12 Gbps), 5G FR2 (which, in some cases, may be capable of achieving throughputs of up to 16.8 Gbps), and/or 6G FR3, among other frequency bands. Moreover, in some examples, it may be desirable to utilize a lower band (e.g., below 2 GHZ) coverage layer for 6G to boost downlink/uplink coverage, especially for co-site deployment of 5G and 6G.

In some aspects, when communicating with one or more network nodes 110 (e.g., such as when communicating with one or more 5G and/or 6G network nodes 110 using one of the carrier aggregation examples described above), the UE 120 may, during some periods of time, not have an active connection with one or more network nodes 110 and, therefore, may not be able to receive signaling dedicated to the UE 120. For example, a UE 120 operating in an RRC idle mode does not have an RRC connection with a network node 110 and, therefore, cannot not receive dedicated signaling from the network node 110. Rather, the UE 120 only receives broadcast information (e.g., SSBs or SIBs). One technique by which the network can establish communication with the UE 120 during such a period of time is through a paging procedure.

In some cases, a paging procedure may include the network node 110 sending a paging message to the UE 120. The paging message may include a request to wake from the idle mode and reconnect to the network. The paging message may be transmitted in a PDSCH communication (e.g., a paging PDSCH). Prior to transmitting the paging PDSCH in a PO, the network node 110 may transmit, and the UE 120 may receive, a PDCCH communication (e.g., a paging PDCCH) scheduling the paging PDSCH. The network node 110 may transmit the paging PDCCH and the paging PDSCH within a PO associated with the UE 120. The PO may be a set of resources in which the UE 120 is configured to check for paging messages for the UE 120.

With increasing network densification and massive IoT deployment in 6G, system load and/or UE resource consumption spent for paging updates may be onerous (e.g., system load and/or UE resource consumption spent for paging updates may be more severe than for LTE and/or 5G paging schemes). For example, in 6G networks, a network node 110 may page a UE 120 for multiple reasons, such as to transmit a PWS notification, to request an RMSI and/or OSI modification for one or multiple UE types, to transmit MT data targeting a single UE or a group of UEs (e.g., voice, SDT, MBS, or similar MT data), or for a similar purpose.

Moreover, in some examples, a paging message may be inapplicable to a UE 120 that is otherwise capable of receiving and decoding the message. For example, depending on the cause of paging, certain UEs may take difference courses of action with different impacts. For example, upon decoding a paging PDCCH, a UE 120 may determine whether to change the UE 120's RRC state, whether to suspend and/or interrupt the UE 120's ongoing activities, or the like. In some cases, if SDT is ongoing at a UE 120 and/or downlink/uplink tunnels have been previously established for DRBs at the UE 120, the UE 120 may not need to decode a paging message. In some other cases, if an SI modification is relevant for a different UE type, a UE 120 may not need to decode a short message associated with the paging message. In that regard, a UE 120 may unnecessarily consume power, computing, and network resources to receive and decode a paging PDCCH for an irrelevant paging message.

Some techniques and apparatuses described herein enable a PEI to be utilized to identify a priority and/or cause of paging, and thus the PEI may be used to indicate to a particular UE 120 whether a paging message is relevant to the UE 120 and/or whether the paging message should be decoded by the UE 120. For example, a PEI communication (e.g., a DCI communication) may include a PWS indication field that may be used to indicate that a paging message is associated with a PWS notification, a primary SI change indication field that may be used to indicate that a paging message is associated with a primary SI change, a secondary SI change indication field that may be used to indicate that a paging message is associated with a secondary SI change, and/or a paging PDSCH indication field that may be used to indicate that a paging message is associated with a paging PDSCH. As a result, a UE 120 receiving the PEI communication may refrain from monitoring and/or decoding inapplicable paging messages, and thus conserve power, computing, and network resources that would have otherwise been consumed by the UE 120 interrupting ongoing activities (e.g., voice, SDT, MBS) and/or monitoring unnecessary POs in an upcoming paging cycle. Additionally, in some aspects, a UE 120 may be configured with a gap pattern, such as for a purpose of switching component carriers and/or downlink BWPs from a component carrier/downlink BWP associated with a PEI occasion to a component carrier/downlink BWP associated with a PO, such as for a purpose of processing a DLRS, a control channel, a data channel, or the like outside an initial BWP. As a result, the gap pattern configuration may enable more flexible resource allocation and thus more efficient usage of network resources.

As indicated above, FIG. 4 is provided as an example. Other examples may differ from what is described with regard to FIG. 4.

FIGS. 5A-5C are diagrams of an example 500 associated with DCI and a gap configuration for a PEI, in accordance with the present disclosure. As shown in FIG. 5A, one or more network nodes 110 (e.g., one or more CUs, DUs, and/or RUs) may communicate with a UE 120. In some aspects, the one or more network nodes 110 and the UE 120 may be part of a wireless network (e.g., wireless network 100). The UE 120 and the one or more network nodes 110 may have established a wireless connection prior to operations shown in FIG. 5A. In some aspects, the one or more network nodes 110 and/or the UE 120 may be capable of multi-RAT (M-RAT) communication. For example, the UE 120 may be an M-RAT UE capable of communicating with both 5G network nodes 110 and 6G network nodes 110, among other examples, such as for a purpose of carrier aggregation.

As shown by reference number 505, the UE 120 may transmit, and the one or more network nodes 110 may receive, a capabilities report. The capabilities report may indicate whether the UE 120 supports a feature and/or one or more parameters related to the feature. For example, the capability information may indicate a capability and/or parameter for receiving a PEI communication. As another example, the capabilities report may indicate a capability and/or parameter for receiving a gap configuration associated with a PEI communication. One or more operations described herein may be based on capability information of the capabilities report. For example, the UE 120 may perform a communication in accordance with the capability information, or may receive configuration information that is in accordance with the capability information. In some aspects, the capabilities report may indicate UE 120 support for receiving a PEI communication that includes a PWS indication, a primary SI change indication, a secondary SI change indication, and/or a paging PDSCH indication, which is described in more detail below in connection with reference number 515. Additionally, or alternatively, the capabilities report may indicate UE 120 support for receiving a front-loaded DLRS associated with a PEI communication, which is described in more detail below in connection with reference number 525. Additionally, or alternatively, the capabilities report may indicate UE 120 support for performing component carrier switching and/or downlink BWP switching in order to receive a paging message in a different component carrier and/or downlink BWP than a component carrier and/or downlink BWP in which a PEI communication is received, which is described in more detail below in connection with reference number 555.

As shown by reference number 510, the one or more network nodes 110 may transmit, and the UE 120 may receive, configuration information. In some aspects, the UE 120 may receive the configuration information via one or more of SI (e.g., a master information block (MIB) and/or a SIB, among other examples), RRC signaling, one or more MAC control elements (MAC-CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication may include a dynamic indication, such as one or more MAC-CEs and/or one or more DCI messages, among other examples.

In some aspects, the configuration information may configure a PEI communication. For example, the configuration information may configure a PEI communication including a PWS indication field, a primary SI change indication field, a secondary SI change indication field, and/or a paging PDSCH indication field. Moreover, the PEI communication may optionally include a TRS availability field. In this way, a UE 120 receiving the PEI communication may identify whether the UE 120 is to monitor an upcoming PO associated with the PEI communication by identifying a purpose of a paging message to be transmitted in the PO based at least in part on one or more of the indications included in the PEI communication. Aspects of identifying whether to monitor an upcoming PO are described in more detail below in connection with reference number 535.

In aspects in which the configuration information configures the PEI communication with the PWS indication field, the PWS indication field may include a quantity of bits (e.g., N bits, where N is greater than or equal to 1) mapped to groups of one or more PWS messages associated with SI. For example, the PWS indication field may include a bitmap comprising N bits, with each configured bit in the N-bit bitmap being mapped to a group of PWS messages carried by SI. In such aspects, if the value of the n-th bit (where 1≤n≤N) in the PWS indication field is set to “1,” a UE capable of decoding the n-th group of PWS messages may be notified to acquire/re-acquire the scheduling information and the SIBs associated with PWS messages in the n-th group. Otherwise, the UE may not be required to acquire and/or re-acquire the PWS messages in the n-th group. In such aspects, the configuration information may further indicate a mapping of the groups of one or more PWS messages to the quantity of bits (e.g., the N bits). Put another way, the grouping of PWS messages and the mapping of grouped PWS messages to the N-bit bitmap may be configured by the one or more network nodes 110, which may be cell-specific, area-specific, or the like.

In aspects in which the configuration information configures the PEI communication with the primary SI change indication field, the primary SI change indication field may include a quantity of bits (e.g., M bits, where M is greater than or equal to 1) mapped to at least one of an MIB associated with primary SI or groups of one or more SIBs associated with the primary SI. For example, the primary SI change indication field may include a bitmap comprising M bits, with each configured bit in the M-bit bitmap being mapped either to the MIB, or a group of SIBs carrying primary SI. In such aspects, if the value of the m-th bit (where 1≤m≤M) in the primary SI change indication field is set to “1,” a UE capable of decoding primary SI in the m-th group may be notified that the primary SI in the m-th group will be changed in the next period of an SI modification in a paging cycle. Otherwise, there may be no change for the primary SI in the m-th group. In such aspects, the configuration information may indicate a mapping of the at least one of the MIB associated with the primary SI or the groups of one or more SIBs associated with the primary SI to the quantity of bits.

In some aspects, the primary SI in the m-th group may apply to all UE types (e.g., fixed wireless access (FWA) UEs, smart phones, IoT UEs, or the like), or the primary SI in the m-th group may be decodable only by a subset of UE types (e.g., IoT UEs). Additionally, or alternatively, if the scheduling information for the secondary SI and/or OSI is mapped to a SIB-x carrying the primary SI, the scheduling information may not be considered as the primary SI. In that regard, a UE monitoring a PEI communication may not be expected to receive a primary SI change indication unless the primary SI mapped to SIB-x will be updated in the next period of the SI modification.

In aspects in which the configuration information configures the PEI communication with the secondary SI change indication field, the secondary SI change indication field may include a quantity of bits (e.g., L bits, where L is greater than or equal to 1) mapped to groups of one or more SIBs associated with secondary SI. For example, the secondary SI change indication field may include a bitmap comprising L bits, with each configured bit in the L-bit bitmap being mapped to a group of SIBs carrying secondary SI (e.g., OSI; supplementary SI for special use cases including sensing, positioning, non-terrestrial network (NTN); or the like). In such aspects, if the value of the l-th bit (where 1≤1≤L) in the secondary SI change indication field is set to “1,” a UE capable of decoding secondary SI in the l-th group may be notified that the secondary SI in the l-th group will be changed in the next period of SI modification in a paging cycle. Otherwise, there may be no change for the secondary SI in the l-th group. In such aspects, the configuration information may further indicate a mapping of the groups of one or more SIBs associated with the secondary SI to the quantity of bits.

In aspects in which the configuration information configures the PEI communication with the paging PDSCH indication field, the paging PDSCH indication field may include a first quantity of bits (e.g., P bits) mapped to a second quantity of POs (e.g., Q POs) associated with the PEI communication and a third quantity of groups of one or more UEs (e.g., K groups of one or more UEs), with the first quantity being a product of the second quantity and the third quantity (e.g., P=Q×K). For example, the paging PDSCH indication field may include a bitmap comprising Q×K bits, with Q corresponding to the total number of POs in a paging cycle, with K corresponding to the total number of UE subgroups in a PO, and with Q and K being configured by higher layer parameters in the primary SI. In such aspects, if the value of the k-th bit (where 1≤k≤K) in the q-th segment of the paging PDSCH indication field is set to “1,” a UE in the k-th subgroup may receive a paging message on the q-th PO. In such aspects, the configuration information may further indicate a mapping of the first quantity of bits (e.g., P bits and/or Q×K bits) to the second quantity of POs (e.g., Q POs) and the third quantity of groups of one or more UEs (e.g., K groups of one or more UEs).

In some aspects, the configuration information may configure one or more other parameters associated with a PEI communication. For example, in some aspects, the configuration information may indicate whether the UE 120 is to monitor PEI occasions (PEI-Os) for a DLRS. For example, as described in more detail below in connection with reference numbers 525 and 530, the one or more network nodes 110 may transmit a front-loaded DLRS with a PEI communication and/or within a PEI-O. In such aspects, the configuration information may indicate that the UE 120 is to monitor the PEI-O for the DLRS. Additionally, or alternatively, in some aspects a PEI communication may optionally include a TRS availability indication field. In such aspects, the configuration information include a TRS indication indicating whether the PEI communication will include the TRS availability indication field.

In some aspects, the UE 120 may be configured to receive a PEI communication in a different component carrier and/or a different downlink BWP than a component carrier and/or a downlink BWP used to transmit paging communications (e.g., a paging PDSCH). In such aspects, the configuration information may configure multiple component carriers and/or multiple downlink BWPs, such as an initial BWP for receiving PEI communications and a separate initial BWP for receiving paging communications. Put another way, in some aspects the configuration information may configure a first component carrier and/or a first downlink BWP associated with a PEI-O and a second component carrier and/or a second downlink BWP associated with a PO, with the first component carrier and/or first downlink BWP being a different component carrier and/or a different downlink BWP than the second component carrier and/or the second downlink BWP. Additionally, or alternatively, the configuration information may configure a gap pattern, such as for a purpose of the UE 120 switching between the first component carrier and/or first downlink BWP and the second component carrier and/or second downlink BWP. For example, the configuration information may configure a gap pattern associated with at least one of switching between the first component carrier and the second component carrier or switching between the first downlink BWP and the second downlink BWP, which is described in more detail below in connection with reference number 555.

The UE 120 may configure itself based at least in part on the configuration information. In some aspects, the UE 120 may be configured to perform one or more operations described herein based at least in part on the configuration information.

In some aspects, the capabilities report described in connection with reference number 505 and/or the configuration information described in connection with reference number 510 may include information transmitted via multiple communications. Additionally, or alternatively, the one or more network nodes 110 may transmit the configuration information, or a communication including at least a portion of the configuration information, before and/or after the UE 120 transmits the capabilities report. For example, the one or more network nodes 110 may transmit a first portion of the configuration information before the capabilities report, the UE 120 may transmit at least a portion of the capabilities report, and the one or more network nodes 110 may transmit a second portion of the configuration information after receiving the capabilities report.

As indicated by reference number 515, in some aspects the one or more network nodes 110 may transmit, and the UE 120 may receive, a PEI communication based at least in part on the configuration information. For example, the UE 120 may monitor a PEI-O 520 for the PEI communication based at least in part on the configuration information, and thus may receive the PEI communication (shown in connection with reference number 515) in the PEI-O 520. In some aspects, the PEI communication may be a DCI communication and/or may be associated with a DCI communication, which is described in more detail below in connection with FIG. 5B. Additionally, or alternatively, as described above in connection with reference number 510, the PEI communication may include one or more fields and/or indications that indicate a purpose of a forthcoming paging communication, such as one or more of the PWS indication field, the primary SI change indication field, the secondary SI change indication field, and/or the paging PDSCH indication field.

As described above in connection with reference number 510, in some aspects the UE 120 may be configured to receive a DLRS that is associated with the PEI communication. Accordingly, in such aspects, and as indicated by reference number 525, the one or more network nodes 110 may transmit, and the UE 120 may receive, a DLRS associated with the PEI communication. In some aspects, the UE 120 may use the DLRS for a purpose of UE synchronization, automatic gain control (AGC) adjustment, channel estimation, and/or presence detection of the PEI communication (e.g., if the UE 120 receives and/or detects the DLRS, the UE 120 may identify that a PEI communication is forthcoming). Put another way, in some aspects the UE 120 may detect a presence of the DLRS in a PEI-O associated with the PEI communication (e.g., PEI-O 520), and the UE 120 may receive the PEI communication in the PEI-O based at least in part on detecting the DLRS (e.g., the UE 120 may monitor for the PEI communication based on detecting the DLRS). Additionally, or alternatively, in some aspects, the UE 120 may identify whether the PEI communication includes the TRS availability indication field based at least in part on receiving the DLRS. For example, the UE 120 may identify a PEI communication format (e.g., whether the PEI communication includes the TRS availability indication field) based at least in part on performing a hypothesis testing procedure associated with the DLRS (e.g., blind decoding with reduced complexity).

Moreover, as indicated using the dashed boxed shown in connection with reference number 530, in some aspects the configuration information may configure the DLRS in a same downlink BWP as a downlink BWP associated with the PEI communication. Additionally, or alternatively, the DLRS may be quasi co-located (QCLed) with the PEI communication (e.g., the DLRS may be transmitted using a same transmission configuration indicator (TCI) state as the PEI communication). Put another way, when a PEI communication is scheduled on the PEI-O 520, a front-loaded DLRS may be transmitted together with the PEI communication, and the DLRS may be jointly configured with a PEI resource in the same downlink BWP and/or the DLRS may be QCLed with the PEI communication. In some aspects, when the UE 120 is configured to monitor for DLRSs in the PEI-O 520, the UE 120 may follow a rule (e.g., configured by the one or more network nodes 110 via the configuration information described above in connection with reference number 510) to determine whether to skip monitoring POs in the next paging cycle when the presence of the DLRS is not detected on a PEI-O (e.g., when energy detection based on the DLRS fails). Moreover, as described above in connection with reference number 510, in aspects employing the front-loaded DLRS, configuration and/or activation of the front-loaded DLRS may be transmitted by the one or more network nodes 110 to the UE 120 by SI, RRC signaling, one or more MAC-CEs, DCI, and/or the like.

As indicated by reference number 535, the UE 120 may identify whether to monitor a PO associated with the PEI communication based at least in part on the PWS indication field, the primary SI change indication field, the secondary SI change indication field, and/or the paging PDSCH indication field. Put another way, the network node 110 may set one or more bits to “1” in the PWS indication field, the primary SI change indication field, the secondary SI change indication field, and/or the paging PDSCH indication field to indicate a purpose of an upcoming paging communication, and based at least in part on whether the “1” bit(s) indicates that the upcoming paging communication is applicable to the UE 120, the UE 120 May selectively monitor the paging communication. In this way, when a purpose of the upcoming paging communication is not applicable to the UE 120, the UE 120 may refrain from monitoring the paging communication, thereby conserving power, computing, and network resources that would have otherwise been consumed monitoring inapplicable paging occasions. On the other hand, when a purpose of the upcoming paging communication is applicable to the UE 120, the UE 120 may monitor the paging communication, thereby receiving important information from the one or more network nodes 110.

More particularly, as indicated by reference number 540, in some aspects the one or more network nodes 110 may transmit, and the UE 120 may receive, a paging communication. In some aspects, the UE 120 may receive the paging communication in a PO 545 associated with the PEI communication. In some aspects, receiving the paging communication may include decoding DCI associated with the paging communication (e.g., decoding a paging PDCCH) and/or decoding a paging message associated with the paging communication (e.g., decoding a paging PDSCH). Moreover, as indicated by using a dashed line in FIG. 5A, the UE 120 may selectively receive the paging communication based on whether a purpose of the upcoming paging communication (as indicated by the one or more indications in the PEI communication) is applicable to the UE 120.

In aspects in which the configuration information described above in connection with reference number 510 configures the UE 120 with a gap pattern to receive the paging communication, the UE 120 may receive the paging communication in a configured gap 550, which is described in more detail below in connection with FIG. 5C. Additionally, or alternatively, in aspects in which the configuration information described above in connection with reference number 510 configures the UE 120 multiple component carriers and/or downlink BWPs, such as a first component carrier and/or a first downlink BWP associated with the PEI-O 520 and a second component carrier and/or a second downlink BWP associated with the PO 545, the UE 120 may switch between component carriers and/or downlink BWPs to receive the paging communication, as indicated by reference number 555.

FIG. 5B shows an example DCI communication 558 that may be used as a PEI communication, according to some aspects described herein. As shown in FIG. 5B, the DCI communication 558 may include a PEI payload 559 and a cyclic redundancy check (CRC) 560 attached to the PEI payload 559, among other portions. The PEI payload 559 may include one or more indication fields, such as one or more of the indication fields described above in connection with reference numbers 510 and 515. For example, the DCI communication 558 may include a DCI field for PWS notification (e.g., the PWS indication field), which may include a bitmap of N bits, as described above. Additionally, or alternatively, the DCI communication 558 may include a DCI field for primary SI change indication (e.g., a primary SI change indication field), which may include a bitmap of M bits, as described above. Additionally, or alternatively, the DCI communication 558 may include a DCI field for secondary SI change indication (e.g., a secondary SI change indication field), which may include a bitmap of L bits, as described above. Additionally, or alternatively, the DCI communication 558 may include a paging message indication based on UE subgrouping (e.g., a paging PDSCH indication field), which may include a bitmap of Q×K bits, as described above. Optionally, the DCI communication 558 may include a TRS availability indication field, as described above.

In some aspects, the DCI field for PWS notification (e.g., the PWS indication field), the DCI field for primary SI change indication (e.g., the primary SI change indication field), and/or the DCI field for secondary SI change indication (e.g., the secondary SI change indication field) may be configured with groupings based on a priority and/or a type of SI. In such aspects, the DCI field for PWS notification, the DCI field for primary SI change indication, and/or the DCI field for secondary SI change indication may enable separate indications for a short message with finer granularity than other PEI communications. Moreover, the paging message indication based on UE subgrouping (e.g., the paging PDSCH indication field) may enable separate notifications for paging messages. In this way, the DCI communication 558 may enable UE power saving in RRC idle and/or inactive modes by enabling the UE to skip unnecessary POs (e.g., by enabling the UE to perform SDT and/or paging message rejection).

As shown in FIG. 5C, in some aspects a UE may be configured with a gap configuration and/or may receive a paging communication in a gap (e.g., gap 550). More particularly, as indicated by reference number 565, in some aspects a UE may be configured with two initial BWPs. For example, in the example shown in FIG. 5C, and as indicated by reference number 570, the UE may be configured with an initial downlink BWP shared by M-RATs. For example, the initial downlink BWP indicated by reference number 570 may be associated with a cell-defining SSB (CD-SSB), common search space (CSS) sets for SI and/or paging, or the like. In some aspects, the initial downlink BWP may be associated with a PO used to receive a paging message (e.g., a paging PDCCH and/or a paging PDSCH). Additionally, or alternatively, the initial downlink BWP may be configured on an anchor carrier in a low frequency band. For example, for a 6G UE, the anchor carrier may be a dedicated carrier for 6G on newly opened spectrum (e.g., FR3), a dedicated carrier for 6G standalone (SA) on spectrum reused from a previous generation RAT, or a M-RAT carrier (e.g., a carrier shared with 5G, 4G, or the like).

Moreover, as indicated by reference number 575, the UE may be configured with a separate initial downlink BWP, such as for a purpose of traffic offloading. The separate initial downlink BWP indicated by reference number 575 may be associated with a non-cell defining SSB (NCD-SSB), CSS sets for random access (RA), SDT, and/or PEI, or the like. In some aspects, the separate initial downlink BWP may be associated with a PEI communication (e.g., may be associated with a PEI-O). That is, in some aspects, a PO and the PEI-O may be configured either on the same anchor carrier or on different carriers for traffic offloading. When the PO and the PEI-O are configured on the same carrier, the PO and the PEI-O may be configured either in the same initial downlink BWP (not shown), or, alternatively, in different downlink BWPs (as indicated in FIG. 5C). When the UE is configured with two initial downlink BWPs, the two initial BWPs may be linked for the UE, as indicated by reference number 580, such as via the configuration information described above in connection with reference number 510.

Moreover, as indicated by reference number 585, the UE may be configured to switch between component carriers and/or downlink BWPs, such as for a purpose of receiving a PEI communication in one component carrier and/or downlink BWP and receiving a paging message in the other component carrier and/or downlink BWP. For example, when PEI-O and PO are configured in different downlink BWPs (e.g., for traffic offloading, co-existence of different UE types, or the like), a first gap pattern type (sometimes referred to as a Type-A gap pattern) may be configured for the UE in order for the UE to switch BWPs without terminating any ongoing activities (e.g., voice, SDT, MBS) in the active downlink BWP. In that regard, the Type-A gap pattern may be configured to accommodate interruption time resulting from BWP switching, paging reception (e.g., paging DCI decoding and paging message decoding), and/or SI acquisition. Similarly, when the PO and the PEI-O are configured on different carriers, a second gap pattern type (sometimes referred to as a Type-B gap pattern) may be configured for the UE in order for the UE to switch carriers without terminating any ongoing activities (e.g., voice, SDT, MBS) in the active downlink BWP. In that regard, the Type-B gap pattern may be configured to accommodate the interruption time resulting from BWP switching, paging reception (e.g., paging DCI decoding and/or paging message decoding), and/or SI acquisition.

For example, as indicated by reference number 590, the UE may be performing an ongoing activity, such as an SDT reception in the example shown in FIG. 5C. In this example, the UE may be performing the SDT reception using the separate initial downlink BWP (e.g., the downlink BWP described above in connection with reference number 575). Moreover, the UE may receive a PEI communication (e.g., the PEI communication described above in connection with reference number 515), such as in a PEI-O associated with the separate initial downlink BWP (e.g., the PEI-O 520). For example, the UE may receive a PEI communication indicating that a PWS notification is to be transmitted (e.g., via the PWS indication field), an SI change is to be performed (e.g., via the primary SI change indication field or the second SI change indication field), or the like.

Accordingly, upon identifying that the forthcoming paging communication is applicable to the UE, the UE may receive the paging message in a PO (e.g., PO 545) associated with the initial downlink BWP (e.g., the downlink BWP described above in connection with reference number 570). More particularly, as indicated by reference number 592, the UE may be configured (e.g., via UE assistance information (UAI)) with a gap pattern (e.g., a Type-A gap pattern, a Type-B gap pattern, or the like) for receiving the paging message. Accordingly, as indicated by reference number 594, the UE may switch component carriers and/or downlink BWPs (e.g., switch between the separate initial downlink BWP and the initial downlink BWP) and camp on the initial downlink BWP (e.g., the downlink BWP shared by M-RATs). As indicated by reference number 596, the UE may receive the paging message (e.g., in this example, by acquiring and/or re-acquiring SI in the PO) in the initial downlink BWP shared by M-RATs. As indicated by reference number 598, the UE may then switch between the initial downlink BWP and the separate downlink BWP, such as for a purpose of resuming SDT reception in the separate initial downlink BWP.

Based at least in part on using a PEI communication to identify a priority and/or a cause of paging, the UE 120 and/or the one or more network nodes 110 may conserve computing, power, network, and/or communication resources that may have otherwise been consumed traditional paging processes. For example, based at least in part on using a PEI communication to identify a priority and/or a cause of paging, the UE 120 may refrain from monitoring and/or decoding inapplicable paging messages, and thus conserve power, computing, and network resources that would have otherwise been consumed by the UE 120 interrupting ongoing activities (e.g., voice, SDT, MBS) and/or monitoring unnecessary POs in an upcoming paging cycle. Additionally, or alternatively, based at least in part on configuring a UE 120 with a gap pattern to receive a paging message, the UE 120 and/or the one or more network nodes 110 may conserve computing, power, network, and/or communication resources that may have otherwise been consumed traditional paging processes. For example, configuring a UE 120 with a gap pattern to receive a paging message may enable more flexible resource allocation and thus more efficient usage of network resources.

As indicated above, FIGS. 5A-5C are provided as an example. Other examples may differ from what is described with respect to FIGS. 5A-5C.

FIG. 6 is a diagram illustrating an example process 600 performed, for example, at a UE or an apparatus of a UE, in accordance with the present disclosure. Example process 600 is an example where the apparatus or the UE (e.g., UE 120) performs operations associated with DCI for a PEI.

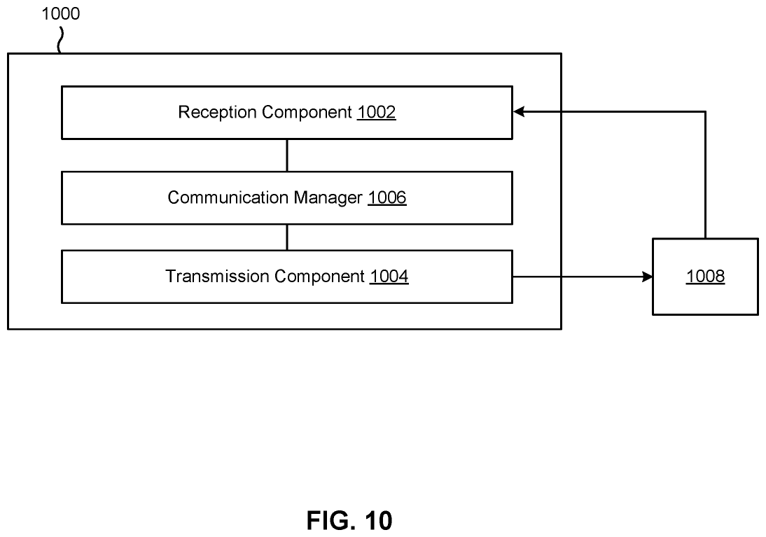

As shown in FIG. 6, in some aspects, process 600 may include receiving configuration information that configures a PEI communication, the PEI communication including at least one of a PWS indication field, a primary SI change indication field, a secondary SI change indication field, or a paging PDSCH indication field (block 610). For example, the UE (e.g., using reception component 1002 and/or communication manager 1006, depicted in FIG. 10) may receive configuration information that configures a PEI communication, the PEI communication including at least one of a PWS indication field, a primary SI change indication field, a secondary SI change indication field, or a paging PDSCH indication field, as described above.

As further shown in FIG. 6, in some aspects, process 600 may include receiving the PEI communication based at least in part on the configuration information (block 620). For example, the UE (e.g., using reception component 1002 and/or communication manager 1006, depicted in FIG. 10) may receive the PEI communication based at least in part on the configuration information, as described above.

Process 600 may include additional aspects, such as any single aspect or any combination of aspects described below and/or in connection with one or more other processes described elsewhere herein.

In a first aspect, the PEI communication is associated with downlink control information.

In a second aspect, alone or in combination with the first aspect, process 600 includes identifying whether to monitor a paging occasion associated with the PEI communication based at least in part on the at least one of the PWS indication field, the primary SI change indication field, the secondary SI change indication field, or the paging PDSCH indication field.

In a third aspect, alone or in combination with one or more of the first and second aspects, the PEI communication further includes a tracking reference signal availability indication field.

In a fourth aspect, alone or in combination with one or more of the first through third aspects, the PEI communication includes the PWS indication field, and the PWS indication field includes a quantity of bits mapped to groups of one or more PWS messages associated with SI.

In a fifth aspect, alone or in combination with one or more of the first through fourth aspects, the configuration information indicates a mapping of the groups of one or more PWS messages to the quantity of bits.

In a sixth aspect, alone or in combination with one or more of the first through fifth aspects, the PEI communication includes the primary SI change indication field, and the primary SI change indication field includes a quantity of bits mapped to at least one of a MIB associated with primary SI or groups of one or more SIBs associated with the primary SI.

In a seventh aspect, alone or in combination with one or more of the first through sixth aspects, the configuration information indicates a mapping of the at least one of the MIB associated with the primary SI or the groups of one or more SIBs associated with the primary SI to the quantity of bits.

In an eighth aspect, alone or in combination with one or more of the first through seventh aspects, the PEI communication includes the secondary SI change indication field, and the secondary SI change indication field includes a quantity of bits mapped to groups of one or more SIBs associated with secondary SI.

In a ninth aspect, alone or in combination with one or more of the first through eighth aspects, the configuration information indicates a mapping of the groups of one or more SIBs associated with the secondary SI to the quantity of bits.

In a tenth aspect, alone or in combination with one or more of the first through ninth aspects, the PEI communication includes the paging PDSCH indication field, the paging PDSCH indication field includes a first quantity of bits mapped to a second quantity of POs associated with the PEI communication and a third quantity of groups of one or more UEs, and the first quantity is a product of the second quantity and the third quantity.

In an eleventh aspect, alone or in combination with one or more of the first through tenth aspects, the configuration information indicates a mapping of the first quantity of bits to the second quantity of POs and the third quantity of groups of one or more UEs.

In a twelfth aspect, alone or in combination with one or more of the first through eleventh aspects, process 600 includes receiving a DLRS associated with the PEI communication.

In a thirteenth aspect, alone or in combination with one or more of the first through twelfth aspects, the configuration information configures the DLRS in a same downlink BWP as a downlink BWP associated with the PEI communication.

In a fourteenth aspect, alone or in combination with one or more of the first through thirteenth aspects, the DLRS is quasi co-located with the PEI communication.

In a fifteenth aspect, alone or in combination with one or more of the first through fourteenth aspects, the DLRS is associated with at least one of UE synchronization, automatic gain control adjustment, channel estimation, or presence detection of the PEI communication.

In a sixteenth aspect, alone or in combination with one or more of the first through fifteenth aspects, process 600 includes detecting a presence of the DLRS in a PEI occasion associated with the PEI communication, and receiving the PEI communication in the PEI occasion based at least in part on detecting the DLRS.

In a seventeenth aspect, alone or in combination with one or more of the first through sixteenth aspects, the configuration information indicates that the UE is to monitor PEI occasions for the DLRS.

In an eighteenth aspect, alone or in combination with one or more of the first through seventeenth aspects, process 600 includes identifying whether the PEI communication includes a TRS availability indication field based at least in part on receiving the DLRS.

In a nineteenth aspect, alone or in combination with one or more of the first through eighteenth aspects, identifying whether the PEI communication includes the TRS availability indication field is based at least in part on a TRS indication included in the configuration information.

In a twentieth aspect, alone or in combination with one or more of the first through nineteenth aspects, identifying whether the PEI communication includes the TRS availability indication field includes performing a hypothesis testing procedure.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with a gap configuration for a PEI.

As shown in FIG. 7, in some aspects, process 700 may include receiving configuration information indicating: at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP (block 710). For example, the UE (e.g., using reception component 1002 and/or communication manager 1006, depicted in FIG. 10) may receive configuration information indicating: at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP, as described above.

As further shown in FIG. 7, in some aspects, process 700 may include receiving at least one of a PEI communication in the PEI occasion or a paging communication in the paging occasion based at least in part on the configuration information (block 720). For example, the UE (e.g., using reception component 1002 and/or communication manager 1006, depicted in FIG. 10) may receive at least one of a PEI communication in the PEI occasion or a paging communication in the paging occasion based at least in part on the configuration information, as described above.

Process 700 may include additional aspects, such as any single aspect or any combination of aspects described below and/or in connection with one or more other processes described elsewhere herein.

In a first aspect, the configuration information indicates the first component carrier associated with the PEI occasion and the second component carrier associated with the paging occasion, and the first component carrier is a different component carrier than the second component carrier.

In a second aspect, alone or in combination with the first aspect, the configuration information indicates the first downlink BWP associated with the PEI occasion and the second downlink BWP associated with the paging occasion, and the first downlink BWP is a different downlink BWP than the second downlink BWP.

In a third aspect, alone or in combination with one or more of the first and second aspects, process 700 includes performing, based at least in part on the gap pattern, at least one of component carrier switching, downlink BWP switching, reception of the paging communication, or system information acquisition.

In a fourth aspect, alone or in combination with one or more of the first through third aspects, performing the at least one of the component carrier switching, the downlink BWP switching, the reception of the paging communication, or the system information acquisition includes performing the reception of the paging communication, and performing the reception the paging communication includes at least one of decoding downlink communication information associated with the paging communication or decoding a paging message associated with the paging communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with DCI for a PEI.

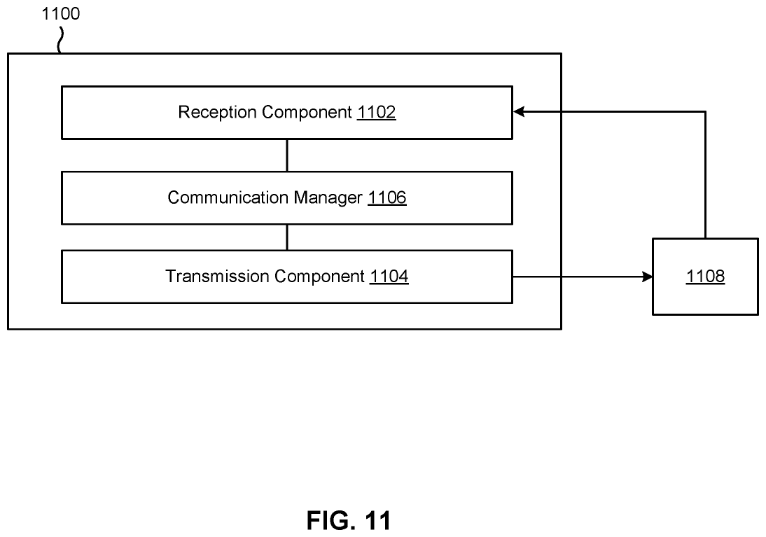

As shown in FIG. 8, in some aspects, process 800 may include transmitting, to a UE, configuration information that configures a PEI communication, the PEI communication including at least one of a PWS indication field, a primary SI change indication field, a secondary SI change indication field, or a paging PDSCH indication field (block 810). For example, the network node (e.g., using transmission component 1104 and/or communication manager 1106, depicted in FIG. 11) may transmit, to a UE, configuration information that configures a PEI communication, the PEI communication including at least one of a PWS indication field, a primary SI change indication field, a secondary SI change indication field, or a paging PDSCH indication field, as described above.

As further shown in FIG. 8, in some aspects, process 800 may include transmitting, to the UE, the PEI communication based at least in part on the configuration information (block 820). For example, the network node (e.g., using transmission component 1104 and/or communication manager 1106, depicted in FIG. 11) may transmit, to the UE, the PEI communication based at least in part on the configuration information, as described above.

Process 800 may include additional aspects, such as any single aspect or any combination of aspects described below and/or in connection with one or more other processes described elsewhere herein.

In a first aspect, the PEI communication is associated with downlink control information.

In a second aspect, alone or in combination with the first aspect, the PEI communication further includes a tracking reference signal availability indication field.

In a third aspect, alone or in combination with one or more of the first and second aspects, the PEI communication includes the PWS indication field, and the PWS indication field includes a quantity of bits mapped to groups of one or more PWS messages associated with SI.

In a fourth aspect, alone or in combination with one or more of the first through third aspects, the configuration information indicates a mapping of the groups of one or more PWS messages to the quantity of bits.

In a fifth aspect, alone or in combination with one or more of the first through fourth aspects, the PEI communication includes the primary SI change indication field, and the primary SI change indication field includes a quantity of bits mapped to at least one of a MIB associated with primary SI or groups of one or more SIBs associated with the primary SI.

In a sixth aspect, alone or in combination with one or more of the first through fifth aspects, the configuration information indicates a mapping of the at least one of the MIB associated with the primary SI or the groups of one or more SIBs associated with the primary SI to the quantity of bits.

In a seventh aspect, alone or in combination with one or more of the first through sixth aspects, the PEI communication includes the secondary SI change indication field, and the secondary SI change indication field includes a quantity of bits mapped to groups of one or more SIBs associated with secondary SI.

In an eighth aspect, alone or in combination with one or more of the first through seventh aspects, the configuration information indicates a mapping of the groups of one or more SIBs associated with the secondary SI to the quantity of bits.

In a ninth aspect, alone or in combination with one or more of the first through eighth aspects, the PEI communication includes the paging PDSCH indication field, the paging PDSCH indication field includes a first quantity of bits mapped to a second quantity of POs associated with the PEI communication and a third quantity of groups of one or more UEs, and the first quantity is a product of the second quantity and the third quantity.

In a tenth aspect, alone or in combination with one or more of the first through ninth aspects, the configuration information indicates a mapping of the first quantity of bits to the second quantity of POs and the third quantity of groups of one or more UEs.

In an eleventh aspect, alone or in combination with one or more of the first through tenth aspects, process 800 includes transmitting, to the UE, a DLRS associated with the PEI communication.

In a twelfth aspect, alone or in combination with one or more of the first through eleventh aspects, the configuration information configures the DLRS in a same downlink BWP as a downlink BWP associated with the PEI communication.

In a thirteenth aspect, alone or in combination with one or more of the first through twelfth aspects, the DLRS is quasi co-located with the PEI communication.

In a fourteenth aspect, alone or in combination with one or more of the first through thirteenth aspects, the DLRS is associated with at least one of UE synchronization, automatic gain control adjustment, channel estimation, or presence detection of the PEI communication.

In a fifteenth aspect, alone or in combination with one or more of the first through fourteenth aspects, the configuration information indicates that the UE is to monitor PEI occasions for the DLRS.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with a gap configuration for a PEI.

As shown in FIG. 9, in some aspects, process 900 may include transmitting, to a UE, configuration information indicating: at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP (block 910). For example, the network node (e.g., using transmission component 1104 and/or communication manager 1106, depicted in FIG. 11) may transmit, to a UE, configuration information indicating: at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP, as described above.

As further shown in FIG. 9, in some aspects, process 900 may include transmitting, to the UE, at least one of a PEI communication in the PEI occasion or a paging communication in the paging occasion based at least in part on the configuration information (block 920). For example, the network node (e.g., using transmission component 1104 and/or communication manager 1106, depicted in FIG. 11) may transmit, to the UE, at least one of a PEI communication in the PEI occasion or a paging communication in the paging occasion based at least in part on the configuration information, as described above.

Process 900 may include additional aspects, such as any single aspect or any combination of aspects described below and/or in connection with one or more other processes described elsewhere herein.

In a first aspect, the configuration information indicates the first component carrier associated with the PEI occasion and the second component carrier associated with the paging occasion, and the first component carrier is a different component carrier than the second component carrier.

In a second aspect, alone or in combination with the first aspect, the configuration information indicates the first downlink BWP associated with the PEI occasion and the second downlink BWP associated with the paging occasion, and the first downlink BWP is a different downlink BWP than the second downlink BWP.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 5A-5C. Additionally, or alternatively, the apparatus 1000 may be configured to perform one or more processes described herein, such as process 600 of FIG. 6, process 700 of FIG. 7, or a combination thereof. In some aspects, the apparatus 1000 and/or one or more components shown in FIG. 10 may include one or more components of the UE 120 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE 120 described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE 120 described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive configuration information that configures a PEI communication, the PEI communication including at least one of a PWS indication field, a primary SI change indication field, a secondary SI change indication field, or a paging PDSCH indication field. The reception component 1002 may receive the PEI communication based at least in part on the configuration information.

The communication manager 1006 may identify whether to monitor a paging occasion associated with the PEI communication based at least in part on the at least one of the PWS indication field, the primary SI change indication field, the secondary SI change indication field, or the paging PDSCH indication field.

The reception component 1002 may receive a DLRS associated with the PEI communication.

The communication manager 1006 may detect a presence of the DLRS in a PEI occasion associated with the PEI communication, wherein receiving the PEI communication in the PEI occasion based at least in part on detecting the DLRS.

The communication manager 1006 may identify whether the PEI communication includes a TRS availability indication field based at least in part on receiving the DLRS.

The reception component 1002 may receive configuration information indicating at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The reception component 1002 may receive at least one of a PEI communication in the PEI occasion or a paging communication in the paging occasion based at least in part on the configuration information.

The communication manager 1006 may perform, based at least in part on the gap pattern, at least one of component carrier switching, downlink BWP switching, reception of the paging communication, or system information acquisition.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 5A-5C. Additionally, or alternatively, the apparatus 1100 may be configured to perform one or more processes described herein, such as process 800 of FIG. 8, process 900 of FIG. 9, or a combination thereof. In some aspects, the apparatus 1100 and/or one or more components shown in FIG. 11 may include one or more components of the network node 110 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node 110 described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node 110 described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a UE, configuration information that configures a PEI communication, the PEI communication including at least one of a PWS indication field, a primary SI change indication field, a secondary SI change indication field, or a paging PDSCH indication field. The transmission component 1104 may transmit, to the UE, the PEI communication based at least in part on the configuration information.

The transmission component 1104 may transmit, to the UE, a DLRS associated with the PEI communication.

The transmission component 1104 may transmit, to a UE, configuration information indicating at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP. The transmission component 1104 may transmit, to the UE, at least one of a PEI communication in the PEI occasion or a paging communication in the paging occasion based at least in part on the configuration information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving configuration information that configures a PEI communication, the PEI communication including at least one of a PWS indication field, a primary SI change indication field, a secondary SI change indication field, or a paging PDSCH indication field; and receiving the PEI communication based at least in part on the configuration information.

Aspect 2: The method of Aspect 1, wherein the PEI communication is associated with downlink control information.

Aspect 3: The method of any of Aspects 1-2, further comprising identifying whether to monitor a paging occasion associated with the PEI communication based at least in part on the at least one of the PWS indication field, the primary SI change indication field, the secondary SI change indication field, or the paging PDSCH indication field.

Aspect 4: The method of any of Aspects 1-3, wherein the PEI communication further includes a tracking reference signal availability indication field.

Aspect 5: The method of any of Aspects 1-4, wherein the PEI communication includes the PWS indication field, and wherein the PWS indication field includes a quantity of bits mapped to groups of one or more PWS messages associated with SI.

Aspect 6: The method of Aspect 5, wherein the configuration information indicates a mapping of the groups of one or more PWS messages to the quantity of bits.

Aspect 7: The method of any of Aspects 1-6, wherein the PEI communication includes the primary SI change indication field, and wherein the primary SI change indication field includes a quantity of bits mapped to at least one of a MIB associated with primary SI or groups of one or more SIBs associated with the primary SI.

Aspect 8: The method of Aspect 7, wherein the configuration information indicates a mapping of the at least one of the MIB associated with the primary SI or the groups of one or more SIBs associated with the primary SI to the quantity of bits.

Aspect 9: The method of any of Aspects 1-8, wherein the PEI communication includes the secondary SI change indication field, and wherein the secondary SI change indication field includes a quantity of bits mapped to groups of one or more SIBs associated with secondary SI.

Aspect 10: The method of Aspect 9, wherein the configuration information indicates a mapping of the groups of one or more SIBs associated with the secondary SI to the quantity of bits.

Aspect 11: The method of any of Aspects 1-10, wherein the PEI communication includes the paging PDSCH indication field, wherein the paging PDSCH indication field includes a first quantity of bits mapped to a second quantity of POs associated with the PEI communication and a third quantity of groups of one or more UEs, and wherein the first quantity is a product of the second quantity and the third quantity.

Aspect 12: The method of Aspect 11, wherein the configuration information indicates a mapping of the first quantity of bits to the second quantity of POs and the third quantity of groups of one or more UEs.

Aspect 13: The method of any of Aspects 1-12, further comprising receiving a DLRS associated with the PEI communication.

Aspect 14: The method of Aspect 13, wherein the configuration information configures the DLRS in a same downlink BWP as a downlink BWP associated with the PEI communication.

Aspect 15: The method of Aspect 13, wherein the DLRS is quasi co-located with the PEI communication.

Aspect 16: The method of Aspect 13, wherein the DLRS is associated with at least one of UE synchronization, automatic gain control adjustment, channel estimation, or presence detection of the PEI communication.

Aspect 17: The method of Aspect 13, further comprising detecting a presence of the DLRS in a PEI occasion associated with the PEI communication; and receiving the PEI communication in the PEI occasion based at least in part on detecting the DLRS.

Aspect 18: The method of Aspect 13, wherein the configuration information indicates that the UE is to monitor PEI occasions for the DLRS.

Aspect 19: The method of Aspect 13, further comprising identifying whether the PEI communication includes a TRS availability indication field based at least in part on receiving the DLRS.

Aspect 20: The method of Aspect 19, wherein identifying whether the PEI communication includes the TRS availability indication field is based at least in part on a TRS indication included in the configuration information.

Aspect 21: The method of Aspect 19, wherein identifying whether the PEI communication includes the TRS availability indication field includes performing a hypothesis testing procedure.

Aspect 22: A method of wireless communication performed by a UE, comprising: receiving configuration information indicating: at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP; and receiving at least one of a PEI communication in the PEI occasion or a paging communication in the paging occasion based at least in part on the configuration information.

Aspect 23: The method of Aspect 22, wherein the configuration information indicates the first component carrier associated with the PEI occasion and the second component carrier associated with the paging occasion, and wherein the first component carrier is a different component carrier than the second component carrier.

Aspect 24: The method of any of Aspects 22-23, wherein the configuration information indicates the first downlink BWP associated with the PEI occasion and the second downlink BWP associated with the paging occasion, and wherein the first downlink BWP is a different downlink BWP than the second downlink BWP.

Aspect 25: The method of any of Aspects 22-24, further comprising performing, based at least in part on the gap pattern, at least one of component carrier switching, downlink BWP switching, reception of the paging communication, or system information acquisition.

Aspect 26: The method of Aspect 25, wherein performing the at least one of the component carrier switching, the downlink BWP switching, the reception of the paging communication, or the system information acquisition includes performing the reception of the paging communication, and wherein performing the reception the paging communication includes at least one of decoding downlink communication information associated with the paging communication or decoding a paging message associated with the paging communication.

Aspect 27: A method of wireless communication performed by a network node, comprising: transmitting, to a UE, configuration information that configures a PEI communication, the PEI communication including at least one of a PWS indication field, a primary SI change indication field, a secondary SI change indication field, or a paging PDSCH indication field; and transmitting, to the UE, the PEI communication based at least in part on the configuration information.

Aspect 28: The method of Aspect 27, wherein the PEI communication is associated with downlink control information.

Aspect 29: The method of any of Aspects 27-28, wherein the PEI communication further includes a tracking reference signal availability indication field.

Aspect 30: The method of any of Aspects 27-29, wherein the PEI communication includes the PWS indication field, and wherein the PWS indication field includes a quantity of bits mapped to groups of one or more PWS messages associated with SI.

Aspect 31: The method of Aspect 30, wherein the configuration information indicates a mapping of the groups of one or more PWS messages to the quantity of bits.

Aspect 32: The method of any of Aspects 27-31, wherein the PEI communication includes the primary SI change indication field, and wherein the primary SI change indication field includes a quantity of bits mapped to at least one of a MIB associated with primary SI or groups of one or more SIBs associated with the primary SI.

Aspect 33: The method of Aspect 32, wherein the configuration information indicates a mapping of the at least one of the MIB associated with the primary SI or the groups of one or more SIBs associated with the primary SI to the quantity of bits.

Aspect 34: The method of any of Aspects 27-33, wherein the PEI communication includes the secondary SI change indication field, and wherein the secondary SI change indication field includes a quantity of bits mapped to groups of one or more SIBs associated with secondary SI.

Aspect 35: The method of Aspect 34, wherein the configuration information indicates a mapping of the groups of one or more SIBs associated with the secondary SI to the quantity of bits.

Aspect 36: The method of any of Aspects 27-35, wherein the PEI communication includes the paging PDSCH indication field, wherein the paging PDSCH indication field includes a first quantity of bits mapped to a second quantity of POs associated with the PEI communication and a third quantity of groups of one or more UEs, and wherein the first quantity is a product of the second quantity and the third quantity.

Aspect 37: The method of Aspect 36, wherein the configuration information indicates a mapping of the first quantity of bits to the second quantity of POs and the third quantity of groups of one or more UEs.

Aspect 38: The method of any of Aspects 27-37, further comprising transmitting, to the UE, a DLRS associated with the PEI communication.

Aspect 39: The method of Aspect 38, wherein the configuration information configures the DLRS in a same downlink BWP as a downlink BWP associated with the PEI communication.

Aspect 40: The method of Aspect 38, wherein the DLRS is quasi co-located with the PEI communication.

Aspect 41: The method of Aspect 38, wherein the DLRS is associated with at least one of UE synchronization, automatic gain control adjustment, channel estimation, or presence detection of the PEI communication.

Aspect 42: The method of Aspect 38, wherein the configuration information indicates that the UE is to monitor PEI occasions for the DLRS.

Aspect 43: A method of wireless communication performed by a network node, comprising: transmitting, to a UE, configuration information indicating: at least one of a first component carrier associated with a PEI occasion or a first downlink BWP associated with the PEI occasion, at least one of a second component carrier associated with a paging occasion or a second downlink BWP associated with the paging occasion, and a gap pattern associated with at least one of switching between the first component carrier and the second component carrier or switching between the first downlink BWP and the second downlink BWP; and transmitting, to the UE, at least one of a PEI communication in the PEI occasion or a paging communication in the paging occasion based at least in part on the configuration information.

Aspect 44: The method of Aspect 43, wherein the configuration information indicates the first component carrier associated with the PEI occasion and the second component carrier associated with the paging occasion, and wherein the first component carrier is a different component carrier than the second component carrier.

Aspect 45: The method of any of Aspects 43-44, wherein the configuration information indicates the first downlink BWP associated with the PEI occasion and the second downlink BWP associated with the paging occasion, and wherein the first downlink BWP is a different downlink BWP than the second downlink BWP.

Aspect 46: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-45.

Aspect 47: An apparatus for wireless communication at a device, the apparatus comprising one or more memories and one or more processors coupled to the one or more memories, the one or more processors configured to cause the device to perform the method of one or more of Aspects 1-45.

Aspect 48: An apparatus for wireless communication, the apparatus comprising at least one means for performing the method of one or more of Aspects 1-45.

Aspect 49: A non-transitory computer-readable medium storing code for wireless communication, the code comprising instructions executable by one or more processors to perform the method of one or more of Aspects 1-45.

Aspect 50: A non-transitory computer-readable medium storing a set of instructions for wireless communication, the set of instructions comprising one or more instructions that, when executed by one or more processors of a device, cause the device to perform the method of one or more of Aspects 1-45.

Aspect 51: A device for wireless communication, the device comprising a processing system that includes one or more processors and one or more memories coupled with the one or more processors, the processing system configured to cause the device to perform the method of one or more of Aspects 1-45.

Aspect 52: An apparatus for wireless communication at a device, the apparatus comprising one or more memories and one or more processors coupled to the one or more memories, the one or more processors individually or collectively configured to cause the device to perform the method of one or more of Aspects 1-45.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, which are configured, individually or in any combination, to:
receive configuration information that configures a paging early indication (PEI) communication, the PEI communication including at least one of a public warning system (PWS) indication field, a primary system information (SI) change indication field, a secondary SI change indication field, or a paging physical downlink shared channel (PDSCH) indication field; and
receive the PEI communication based at least in part on the configuration information.

2. The UE of claim 1, wherein the PEI communication is associated with downlink control information.

3. The UE of claim 1, wherein the one or more processors are further configured, individually or collectively, to identify whether to monitor a paging occasion associated with the PEI communication based at least in part on the at least one of the PWS indication field, the primary SI change indication field, the secondary SI change indication field, or the paging PDSCH indication field.

4. The UE of claim 1, wherein the PEI communication further includes a tracking reference signal availability indication field.

5. The UE of claim 1, wherein the PEI communication includes the PWS indication field, and
wherein the PWS indication field includes a quantity of bits mapped to groups of one or more PWS messages associated with SI.

6. The UE of claim 5, wherein the configuration information indicates a mapping of the groups of one or more PWS messages to the quantity of bits.

7. The UE of claim 1, wherein the PEI communication includes the primary SI change indication field, and
wherein the primary SI change indication field includes a quantity of bits mapped to at least one of a master information block (MIB) associated with primary SI or groups of one or more system information blocks (SIBs) associated with the primary SI.

8. The UE of claim 7, wherein the configuration information indicates a mapping of the at least one of the MIB associated with the primary SI or the groups of one or more SIBs associated with the primary SI to the quantity of bits.

9. The UE of claim 1, wherein the PEI communication includes the secondary SI change indication field, and
wherein the secondary SI change indication field includes a quantity of bits mapped to groups of one or more system information blocks (SIBs) associated with secondary SI.

10. The UE of claim 9, wherein the configuration information indicates a mapping of the groups of one or more SIBs associated with the secondary SI to the quantity of bits.

11. The UE of claim 1, wherein the PEI communication includes the paging PDSCH indication field,
wherein the paging PDSCH indication field includes a first quantity of bits mapped to a second quantity of paging occasions (POs) associated with the PEI communication and a third quantity of groups of one or more UEs, and
wherein the first quantity is a product of the second quantity and the third quantity.

12. The UE of claim 11, wherein the configuration information indicates a mapping of the first quantity of bits to the second quantity of POs and the third quantity of groups of one or more UEs.

13. The UE of claim 1, wherein the one or more processors are further configured, individually or collectively, to receive a downlink reference signal (DLRS) associated with the PEI communication.

14. The UE of claim 13, wherein the configuration information configures the DLRS in a same downlink bandwidth part (BWP) as a downlink BWP associated with the PEI communication.

15. The UE of claim 13, wherein the DLRS is quasi co-located with the PEI communication.

16. The UE of claim 13, wherein the DLRS is associated with at least one of UE synchronization, automatic gain control adjustment, channel estimation, or presence detection of the PEI communication.

17. The UE of claim 13, wherein the one or more processors are further configured, individually or collectively, to:
detect a presence of the DLRS in a PEI occasion associated with the PEI communication; and
receive the PEI communication in the PEI occasion based at least in part on detecting the DLRS.

18. The UE of claim 13, wherein the configuration information indicates that the UE is to monitor PEI occasions for the DLRS.

19. The UE of claim 13, wherein the one or more processors are further configured, individually or collectively, to identify whether the PEI communication includes a tracking reference signal (TRS) availability indication field based at least in part on receiving the DLRS.

20. The UE of claim 19, wherein the one or more processors, to identify whether the PEI communication includes the TRS availability indication field, are configured, individually or collectively, to identify whether the PEI communication includes the TRS availability indication field is based at least in part on a TRS indication included in the configuration information.

21. The UE of claim 19, wherein the one or more processors, to identify whether the PEI communication includes the TRS availability indication field, are configured, individually or collectively, to identify whether the PEI communication includes the TRS availability indication field by performing a hypothesis testing procedure.

22. A user equipment (UE) for wireless communication, comprising:
one or more memories; and
one or more processors, coupled to the one or more memories, which are configured, individually or in any combination, to:
receive configuration information indicating:
at least one of a first component carrier associated with a paging early indication (PEI) occasion or a first downlink bandwidth part (BWP) associated with the PEI occasion,
at least one of a second component carrier associated with a paging occasion or a second downlink BWP associated with the paging occasion, and
a gap pattern associated with at least one of switching between the first component carrier and the second component carrier or switching between the first downlink BWP and the second downlink BWP; and
receive at least one of a PEI communication in the PEI occasion or a paging communication in the paging occasion based at least in part on the configuration information.

23. The UE of claim 22, wherein the configuration information indicates the first component carrier associated with the PEI occasion and the second component carrier associated with the paging occasion, and
wherein the first component carrier is a different component carrier than the second component carrier.

24. The UE of claim 22, wherein the configuration information indicates the first downlink BWP associated with the PEI occasion and the second downlink BWP associated with the paging occasion, and
wherein the first downlink BWP is a different downlink BWP than the second downlink BWP.

25. The UE of claim 22, wherein the one or more processors are further configured, individually or collectively, to perform, based at least in part on the gap pattern, at least one of component carrier switching, downlink BWP switching, reception of the paging communication, or system information acquisition.

26. The UE of claim 25, wherein the one or more processors, to perform the at least one of the component carrier switching, the downlink BWP switching, the reception of the paging communication, or the system information acquisition, are configured, individually or collectively, to perform the reception of the paging communication, and
wherein the one or more processors, to perform the reception the paging communication, are configured to decode downlink communication information associated with the paging communication or decode a paging message associated with the paging communication.

27. A method of wireless communication performed by a user equipment (UE), comprising:
receiving configuration information that configures a paging early indication (PEI) communication, the PEI communication including at least one of a public warning system (PWS) indication field, a primary system information (SI) change indication field, a secondary SI change indication field, or a paging physical downlink shared channel (PDSCH) indication field; and
receiving the PEI communication based at least in part on the configuration information.

28. The method of claim 27, further comprising identifying whether to monitor a paging occasion associated with the PEI communication based at least in part on the at least one of the PWS indication field, the primary SI change indication field, the secondary SI change indication field, or the paging PDSCH indication field.

29. A method of wireless communication performed by a user equipment (UE), comprising:
receiving configuration information indicating:
at least one of a first component carrier associated with a paging early indication (PEI) occasion or a first downlink bandwidth part (BWP) associated with the PEI occasion,
at least one of a second component carrier associated with a paging occasion or a second downlink BWP associated with the paging occasion, and
a gap pattern associated with at least one of switching between the first component carrier and the second component carrier or switching between the first downlink BWP and the second downlink BWP; and
receiving at least one of a PEI communication in the PEI occasion or a paging communication in the paging occasion based at least in part on the configuration information.

30. The method of claim 29, further comprising performing, based at least in part on the gap pattern, at least one of component carrier switching, downlink BWP switching, reception of the paging communication, or system information acquisition.
